(19) United States
(12) Patent Application Publication
(10) Pub. No.: US 2025/0197176 A1
(43) Pub. Date: Jun. 19, 2025

(54) MOBILE WORK MACHINE AND DRIVE SYSTEM FOR SUCH A MACHINE

(71) Applicant: Liebherr-Werk Ehingen GmbH, Ehingen/Donau (DE)

(72) Inventor: Marc MEBUS, Illerkirchberg (DE)

(21) Appl. No.: 18/981,138

(22) Filed: Dec. 13, 2024

(30) Foreign Application Priority Data
Dec. 18, 2023 (DE) 10 2023 135 491.4

(51) Int. Cl. B66C 23/84; B66C 23/40

(52) U.S. Cl. CPC B66C 23/84; B66C 23/40

(57) ABSTRACT

The disclosure relates to a mobile work machine, in particular a mobile crane, which comprises a movable undercarriage, a superstructure which is rotatably mounted on the undercarriage and which is separably connected to the undercarriage via a coupling device, and a mechanical power transmission means, wherein the undercarriage comprises a motor and a first shaft that can be mechanically driven by the motor and that is mechanically connected to a second shaft of the superstructure via the power transmission means. In accordance with the disclosure either the power transmission means is mounted rotatably on the undercarriage and is detachably connected to the second shaft via a mechanical interface or the power transmission means is mounted on the superstructure for conjoint rotation and is detachably connected to the first shaft via a mechanical interface. The disclosure further relates to a drive system for a work machine according to the disclosure.

### CROSS REFERENCE TO RELATED APPLICATION

The present application claims priority to German Patent Application No. 10 2023 135 491.4 filed on Dec. 18, 2023. The entire contents of the above-listed application are hereby incorporated by reference for all purposes.

### TECHNICAL FIELD

The present disclosure relates to a mobile work machine, in particular a mobile crane, and to a drive system for such a machine.

### BACKGROUND

Mobile work machines often have a movable undercarriage and a superstructure mounted rotatably thereon, such as rail cranes, crawler cranes or mobile cranes. The latter are usually movable on public roads and have a wheeled chassis, for the wheel axles of which certain maximum axle loads must be considered on public roads, depending on the country. In Germany, for example, mobile cranes may be moved with a maximum load of 12 tons per axle. This limits the mass that can be used to increase the load capacity of such mobile cranes.

### SUMMARY

One way of increasing the maximum load capacity of mobile cranes is to remove certain assemblies from the mobile crane for movement on public roads. However, this increases the effort required to set up the mobile crane so that it is ready to work. However, this effort is offset by the higher achievable load capacity, so that this effort may be justified in certain cases. Possible assemblies to be dismantled are the superstructure and the boom, which is configured as a telescopic boom on most mobile cranes. These assemblies can be transported to the site as separate transport units with their large mass. The mobile crane with its undercarriage can be driven to the site of operation on public roads alone. However, these considerations regarding assemblies that can be dismantled and transported separately apply not only to mobile cranes, but also to other mobile machinery that can be dismantled into separate transport units.

Larger mobile cranes are usually equipped with two motors, an undercarriage motor in the undercarriage and a superstructure motor in the superstructure. The undercarriage motor is usually used to drive the entire crane, while the superstructure motor usually drives hydraulic motors that are used to perform the usual crane functions (luffing the boom, rotating the superstructure, operating cable winches, etc.).

Mobile cranes in single-engine configuration are also known, which only have an engine in the undercarriage. As the superstructure motor and its weight are omitted, this weight can be invested in the crane lifting capacity and/or in the stability of various assemblies. The consumers of the superstructure must therefore be supplied from the undercarriage. A so-called “hydraulic shaft” is often used for this, in which hydraulic oil is fed into the superstructure via a rotary feedthrough between the undercarriage and superstructure and supplies the respective crane actuators directly or indirectly. However, these hydraulic shafts are not only complex in their configuration, but also make it difficult to remove the superstructure from the undercarriage for transport.

Alternatively, a mechanical linkage, which is driven by the undercarriage engine, can be guided into the superstructure via the rotary feedthrough in order to drive a pump transfer gearbox there, for example. However, such solutions have so far only been used for smaller mobile cranes where the superstructure is not removed for transport, as separating the mechanical linkage would be too costly with previous solutions.

Against this background, the present disclosure addresses the object of providing a mobile work machine of the same type, the superstructure of which can be quickly and easily separated from the undercarriage for transport and connected to the undercarriage for setting up in the working state.

According to the disclosure, this object is achieved by a work machine and by a drive system as described herein.

Accordingly, a mobile work machine, in particular a mobile crane, is proposed, which comprises a movable undercarriage, a superstructure rotatably mounted on the undercarriage and a mechanical power transmission means. The superstructure is separably connected to the undercarriage via a coupling device so that it can be removed from the undercarriage for separate transport of the undercarriage and superstructure. In the present case, the separable connection between the superstructure and the undercarriage refers to a connection that is configured for the regular removal and attachment of the superstructure.

This separation can be carried out frequently and without significant wear, which does not apply in particular to separation at the expansion bolts of a roller and cage assembly, as these bolts would have to be replaced after a few separation processes at the latest. Consequently, the aforementioned separable connection between the superstructure and the undercarriage does not comprise a separation at the expansion bolts of a roller and cage assembly that are usually provided. Instead, the work machine according to the disclosure optionally comprises a quick-release coupling device for the separation between the superstructure and the undercarriage in order to be able to carry out the assembly and disassembly of the superstructure quickly and easily. The quick-release coupling device can comprise a bolt connection.

In the present case, a screw connection is not understood to be a quick-release coupling or quick-release coupling device.

The undercarriage comprises a motor and a first shaft that can be mechanically driven by the motor. The superstructure comprises a second shaft, which in particular drives one or more consumers of the superstructure, for example a pump transfer gearbox. The second shaft is mechanically connected or connectable to the first shaft via the power transmission means. The undercarriage motor therefore drives the second shaft mechanically via the first shaft and the power transmission means. This eliminates the need for a separate superstructure motor, which saves weight. The energy is transmitted from the undercarriage to the superstructure mechanically and not hydraulically, so that a complicated and leak-prone “hydraulic shaft” is not required.

According to a first alternative, in accordance with the disclosure the power transmission means is rotatably mounted on the undercarriage and detachably connected to the second shaft via a mechanical interface. In this case, the power transmission means can be regarded as part of the undercarriage and can remain on the undercarriage when the undercarriage is moved separately. Optionally, the power transmission means always remains connected to the undercarriage in this case, in particular also in a working state in which the superstructure is rotatably connected to the undercarriage. In order to be able to remove the superstructure from the undercarriage, the second shaft must be separated from the power transmission means. This can be done quickly and easily via a mechanical interface provided specifically for this purpose, which in the simplest case can comprise a screw connection, but optionally a quick-release coupling.

According to a second alternative, in accordance with the disclosure the power transmission means can be mounted non-rotatably on the superstructure and detachably connected to the first shaft via a mechanical interface. In this case, the power transmission means can be regarded as part of the superstructure and can remain on the superstructure when the undercarriage is moved separately. Optionally in this case, the power transmission means always remains connected to the superstructure, in particular also in a working state in which the superstructure is rotatably connected to the undercarriage. In order to be able to remove the superstructure from the undercarriage, the first shaft must be separated from the power transmission means. This can be done quickly and easily via a mechanical interface provided specifically for this purpose, which in the simplest case can comprise a screw connection, but optionally a quick-release coupling.

The separation between the undercarriage and superstructure therefore takes place at the aforementioned mechanical interface between the power transmission means and the second shaft or between the power transmission means and the first shaft (and in particular at a slewing ring between the undercarriage and superstructure).

In the event that the power transmission means is rotatably mounted on the undercarriage, it can rotate with the superstructure when the work machine is in the working state, i.e. when the superstructure is attached to the undercarriage. As a result, the mechanical power transmission from the undercarriage to the superstructure is independent of the rotational position of the superstructure relative to the undercarriage. This also applies to the alternative case in which the power transmission means is non-rotatably connected to the superstructure, since in this case it is optionally not connected to the undercarriage (apart from the first shaft). The solution according to the disclosure thus enables mechanical energy or power transmission from the undercarriage to the superstructure irrespective of the size of the work machine and thus, in particular, single-motor operation for devices (e.g. large mobile cranes) in which the superstructure is regularly dismantled for transport.

In the event that the power transmission means is rotatably mounted on the undercarriage, the power transmission means can optionally be arranged on an upper side of the undercarriage so that a connection to the superstructure or the second shaft can be easily implemented. In particular, the power transmission means can be located in the region of a slewing ring between the superstructure and undercarriage.

The first alternative (power transmission means is rotatably mounted on the undercarriage) may be used if, for example, there is not enough space for the power transmission means on or in the superstructure.

The undercarriage can have a wheeled chassis, although other chassis such as a rail chassis or a caterpillar are also conceivable. In particular, the superstructure is mounted on the undercarriage so that it can rotate about a vertical axis.

In one possible embodiment, the power transmission means is or comprises an angular gearing. The angular gearing deflects the mechanical linkage running between the lower and superstructure laterally and, in an optional embodiment, can also have a fixed or adjustable torque ratio. The angular gearing optionally comprises a first mechanical interface via which the angular gearing is mechanically detachably connected or connectable to the second shaft and/or a second mechanical interface via which the angular gearing is mechanically detachably connected or connectable to the first shaft.

Optionally, two mechanical interfaces can also be provided, via which the power transmission means is connected to the first and second shafts respectively. Optionally, when the superstructure and undercarriage are separated, decoupling only takes place at one of the mechanical interfaces. Both mechanical interfaces can each comprise a quick-release coupling (i.e. the coupling or uncoupling is not carried out via a simple screw connection). Alternatively, one of the mechanical interfaces can comprise a quick-release coupling, while the other mechanical interface can comprise a screw connection, for example.

In a further possible embodiment, it is provided that the power transmission means is rotatably mounted on the undercarriage and is detachably connected to the second shaft via a mechanical interface, wherein the work machine comprises a bearing arrangement which supports the power transmission means and rotatably connects it to the undercarriage. The bearing arrangement optionally comprises a first slewing ring connected to the undercarriage. This is formed in particular as a rolling bearing. Optionally, the first slewing ring of the bearing arrangement is not actively rotatable, but the bearing arrangement or the power transmission means is coupled to the superstructure in such a way that it rotates passively with the superstructure. The first slewing ring optionally forms a rotary feedthrough for the first shaft, which is guided from the inside of the undercarriage through the slewing ring to the outside to the power transmission means.

In a further possible embodiment, it is provided that the coupling device comprises a slewing ring (referred to here as a “second slewing ring” to distinguish it from any first slewing ring provided in the bearing arrangement). This is optionally formed as a rolling bearing, in particular as a live ring. Optionally, the superstructure has a rotary drive for actively rotating the superstructure via the slewing ring, which can be hydraulic, for example. The first and second slewing rings can be concentric.

The second slewing ring optionally comprises a first slewing ring part connected to the undercarriage and a second slewing ring part connected to the superstructure, which are detachably connected to each other via a quick-release coupling device (“quick connection”). This allows the superstructure to be separated from or connected to the undercarriage relatively quickly and easily, e.g. in order to transport the undercarriage and superstructure as separate transport units. The quick-release coupling device can be based on a type of tongue-and-groove connection between the aforementioned slewing ring parts, which can be releasably locked together by several bolts. However, different embodiments are conceivable here that allow quick and easy mechanical assembly or disassembly of the superstructure and are configured for this purpose.

In a further possible embodiment, it is provided that said bearing arrangement is arranged within said second slewing ring. The two slewing rings are optionally configured to rotate independently of each other. The slewing rings can each comprise rolling bearings, which can be arranged concentrically to the axis of rotation of the superstructure.

In a further possible embodiment, it is envisaged that the bearing arrangement comprises at least one damping element, via which the power transmission means is connected to the undercarriage in a vibration-damped manner. The at least one damping element can be an elastic component such as a spring or an elastomer bearing. The at least one damping element equalizes vibrations or relative movements between the undercarriage and superstructure, thereby protecting the mechanical drive system between the undercarriage and superstructure. The bearing arrangement optionally comprises an arrangement of several damping elements symmetrical to an axis of rotation of the power transmission means. For example, an arrangement of four damping elements forming the corners of a rectangle or square is conceivable, wherein another arrangement with fewer (e.g. three) or more than four damping elements is of course also possible.

In a further possible embodiment, it is envisaged that the aforementioned bearing arrangement comprises a driver which interacts with a slip ring arrangement of the coupling device and transmits a rotary movement of the bearing arrangement to a slip ring transmitter of the slip ring arrangement. This means that the driver only has to be adjusted once and can then remain on the undercarriage even when the superstructure is removed.

In a further possible embodiment, it is provided that the first shaft and/or the second shaft comprises a universal-joint shaft. The first shaft and/or the second shaft may comprise several universal-joint shafts which are articulated to one another, for example via Cardan joints. The first shaft can comprise a king shaft and an angular gearing, so that the first shaft can be guided from below, in particular parallel or almost parallel to the axis of rotation of the superstructure, to the power transmission means. The first shaft is guided through the rotary feedthrough between the undercarriage and superstructure via the king shaft. The power transmission means is optionally located on an upper side of the undercarriage.

In a further possible embodiment, it is provided that the mechanical interface, which detachably connects the power transmission means to the first and/or second shaft, is or comprises a quick-release coupling. As a result, the corresponding shaft can be quickly and easily detached from or connected to the power transmission means, which facilitates and accelerates the assembly and disassembly of the superstructure. The quick-release coupling can optionally comprise a first quick-release coupling part with a profiled pin and a second quick-release coupling part with a receptacle profiled to complement the pin, which are plugged onto or into each other and can thus be releasably connected to each other in a frictionally engaged and/or form-fitting manner. Optionally, the connection can be reversibly lockable by means of a locking means, e.g. a bolt or split pin. For example, the aforementioned pin can represent the end of a rotatable shaft of the power transmission means and the receptacle can represent the end of the first and/or second shaft pointing towards the power transmission means (or vice versa).

In a further possible embodiment, it is provided that the work machine comprises a holding device with which the uncoupled shaft can be releasably connected in a bearing position in a state separated from the power transmission means. If the superstructure is removed from the undercarriage and the corresponding shaft is thus separated from the power transmission means, the latter can be secured or held by the holding device. Optionally, the connection between the holding device and the shaft also forms a quick-release coupling as described above.

In the event that the power transmission means is rotatably mounted on the undercarriage, the holding device can be arranged on the superstructure. This means that the second shaft, which is separate from the power transmission means, can be detachably connected to the holding device on the superstructure in the bearing position. In the alternative case where the power transmission means is mounted on the superstructure for conjoint rotation, the holding device can be arranged on the undercarriage to receive the uncoupled first shaft.

In a further possible embodiment, it is provided that the power transmission means is rotatably mounted on the undercarriage, wherein the work machine comprises a locking device by means of which the power transmission means can be locked reversibly and in a rotationally rigid manner either with the undercarriage or with the superstructure. Optionally, in a working state in which the superstructure is connected to the undercarriage, the power transmission means can be connected to the superstructure in a rotationally rigid manner via the locking device, so that the power transmission means rotates with the superstructure when the superstructure rotates relative to the undercarriage. In a transport state in which the superstructure is separated from the undercarriage, the power transmission means can be connected to the undercarriage in a rotationally rigid manner via the locking device so that the power transmission means does not rotate unintentionally when the undercarriage is moved, for example.

The locking device can optionally be actuated remotely, for example by means of a Bowden cable. In the case of manual actuation, the actuating element (e.g. a lever) for locking with the undercarriage or superstructure can be arranged, for example, in the region of the power transmission means (e.g. on a bearing arrangement of the power transmission means) or at another point on the undercarriage. The actuating element should be easily accessible from the outside. Actuator-based actuation is also conceivable and can be carried out via an undercarriage driver's cab or a mobile device, for example.

In a further possible embodiment, it is provided that the locking device comprises a first locking element, which is connected to the bearing arrangement and which can optionally be brought into engagement with a second locking element arranged on the undercarriage or with a third locking element arranged on the superstructure. The first locking element can be a safety latch, for example, which, depending on its position (and that of the superstructure), can be locked with the second or third locking element.

In a further possible embodiment, it is envisaged that the superstructure does not have a drive motor (single-motor operation with supply of the superstructure from the undercarriage). Alternatively or additionally, the superstructure can comprise at least one consumer (e.g. a pump transfer gearbox), wherein all consumers of the superstructure are driven directly or indirectly via the second shaft.

In another possible embodiment, it is envisaged that the work machine is formed as a mobile crane, wherein the undercarriage comprises a wheeled chassis and the superstructure comprises a boom, in particular a telescopic boom. The superstructure can be detached from the undercarriage via the coupling device and transported separately, wherein the undercarriage can optionally be moved independently without the superstructure. The undercarriage optionally has an undercarriage driver's cab, via which the undercarriage can be moved on the road without the superstructure attached. The superstructure can have a superstructure ballast and/or a superstructure driver's cab.

The present disclosure also relates to a drive system for the work machine according to the disclosure. The drive system comprises a motor, a first shaft which can be mechanically driven by the motor, a second shaft, and a power transmission means which is detachably connected to the first and/or second shaft via at least one mechanical interface and mechanically connects the two shafts to one another, as already described above. According to the first alternative described above, the drive system can comprise a slewing ring via which the power transmission means can be connected or is connected rotatably to an undercarriage of the work machine, wherein the power transmission means is detachably connected to the first shaft via a mechanical interface. Alternatively, the power transmission means is connectable or connected non-rotatably to the superstructure.

This obviously results in the same properties and advantages as for the work machine according to the disclosure, so that a repetitive description is dispensed with. In particular, the drive system can be configured in accordance with any of the previously described embodiments or any combination thereof, as far as the aforementioned embodiments relate to the components of the drive system (first shaft, second shaft, power transmission means, motor, bearing arrangement, first slewing ring, locking device, etc.).

### BRIEF DESCRIPTION OF THE FIGURES

Further features, details and advantages of the disclosure can be found in the exemplary embodiments explained below with reference to the figures, in which:

FIG. 1: shows a side view of the mobile work machine according to the disclosure according to an exemplary embodiment;

FIG. 2: shows a perspective view of an exemplary embodiment of the power transmission means in the working state;

FIG. 3: shows a perspective view of the power transmission means mounted on the undercarriage in the transport state;

FIG. 4: shows a perspective view of the superstructure in the transport state;

FIGS. 5-6: show side views of the power transmission means in the locked state with the undercarriage and the superstructure; and

FIG. 7: shows a sectional view through the coupling device according to an exemplary embodiment.

### DETAILED DESCRIPTION

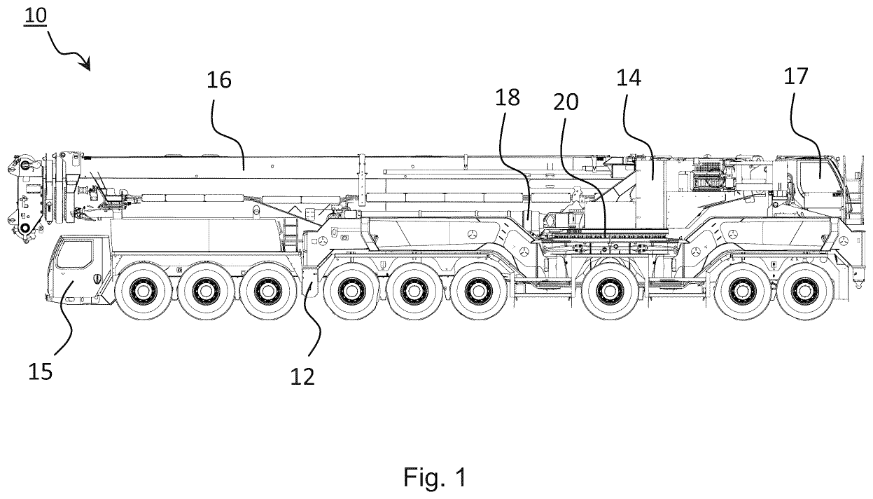

FIG. 1 shows a side view of an exemplary embodiment of the work machine 10 according to the disclosure in the form of a mobile crane. Although the following description of the exemplary embodiments is given with reference to this mobile crane, the drive system according to the disclosure is not limited to such a mobile crane, but can be used on different work machines with undercarriages and superstructures.

The mobile crane 10 comprises an undercarriage 12 with several wheel axles and an undercarriage driver's cab 15 as well as a superstructure 14 mounted on the undercarriage 12 via a coupling device 20 about a vertical axis of rotation with a boom 16 that can be luffed up and down about a horizontal swivel axis. As shown in FIG. 1, the superstructure 14 can also have a superstructure driver's cab 17. In this exemplary embodiment, the boom 16 is configured as a telescopic boom, which can be swiveled about the horizontal swivel axis with the aid of one or more luffing cylinders 18.

The coupling device 20 comprises a slewing ring 23 in the form of a live ring, as is common with larger mobile cranes. The coupling device 20 is configured so that the superstructure 14 can be detached from the undercarriage 12. This allows the superstructure 14 with its considerable dead weight to be transported to the place of use as a separate transport unit independently of the undercarriage 12. The undercarriage 12 can be driven on public roads without the superstructure 14, wherein the permissible axle loads are complied with due to the reduced weight. In order to enable regular mounting and dismounting of the superstructure 14, the coupling device 20 is specially configured for this purpose and optionally comprises a special quick-release coupling device 26, which enables quick and easy mounting and dismounting of the superstructure.

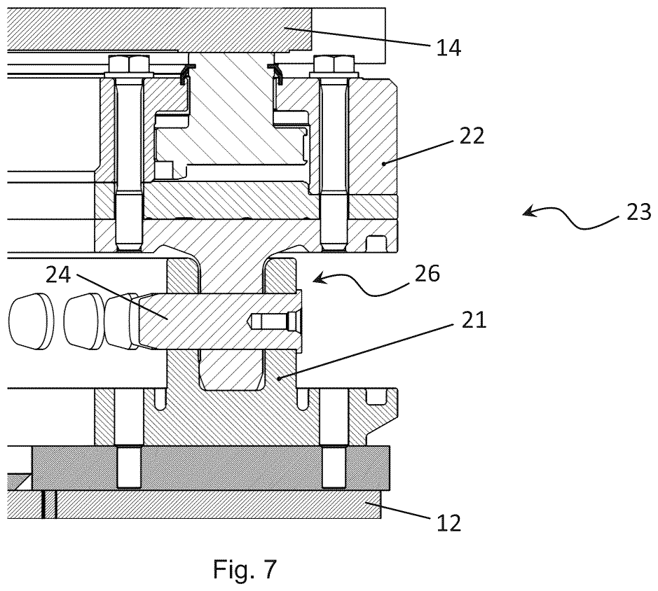

FIG. 7 shows a section through an exemplary embodiment of the swivel joint 23. In this variant, the quick-release coupling device 26 is based on a tongue and groove connection. The slewing ring 23 comprises a first quick-coupling part 21, which is connected, in particular screwed, to the undercarriage 12, and a second quick-coupling part 22, which is connected, in particular screwed, to the superstructure 14. In the exemplary embodiment shown, the first quick-coupling part 21 has an annular circumferential groove, while the second quick-coupling part 22 has a corresponding annular circumferential rib, which lies within the groove when connected. Both quick-coupling parts 21, 22 have a plurality of bolt receptacles distributed around their circumference, through which corresponding locking bolts 24 can be inserted for releasably locking the undercarriage 12 and superstructure 14.

In the exemplary embodiment shown in FIG. 7, the second quick-coupling part 22 comprises the aforementioned live ring, wherein this can alternatively be installed in the first quick-coupling part 21. Likewise, conversely, the first quick-coupling part 21 can comprise the rib and the second quick-coupling part 22 can comprise the groove.

The undercarriage 12 has a motor that drives one or more consumers of the superstructure 14, such as a pump transfer gearbox for supplying the luffing cylinder 18 and other hydraulic consumers. This takes place via a mechanical drive system which extends from the undercarriage 12 through the slewing ring 23 between the undercarriage and the superstructure 12, 14 into the superstructure 14. The drive system comprises a first shaft 51 in the undercarriage 12 and a second shaft 52 in the superstructure 14, which are mechanically coupled to each other by a power transmission means 30. The undercarriage motor drives the first shaft 51 rotationally, wherein the rotary movement is transmitted to the second shaft 52 via the power transmission means 30. The two shafts 51, 52 are formed as universal-joint shafts and can comprise several individual shafts coupled together in an articulated manner. The first shaft 51 is guided substantially vertically, i.e. almost parallel to the axis of rotation of the superstructure 14, through the slewing ring 23 in the direction of the superstructure 14. For this purpose, the first shaft 51 can comprise a king shaft and an angular gearing arranged in the undercarriage 12 in order to deflect the shaft 51 in the direction of the superstructure 14.

The mechanical drive system must be disconnected or decoupled in order to dismantle the superstructure 14. So that this can be done quickly and easily, the power transmission means 30 coupling the first and second shafts 51, 52 to one another has a mechanical interface 40 at which decoupling takes place.

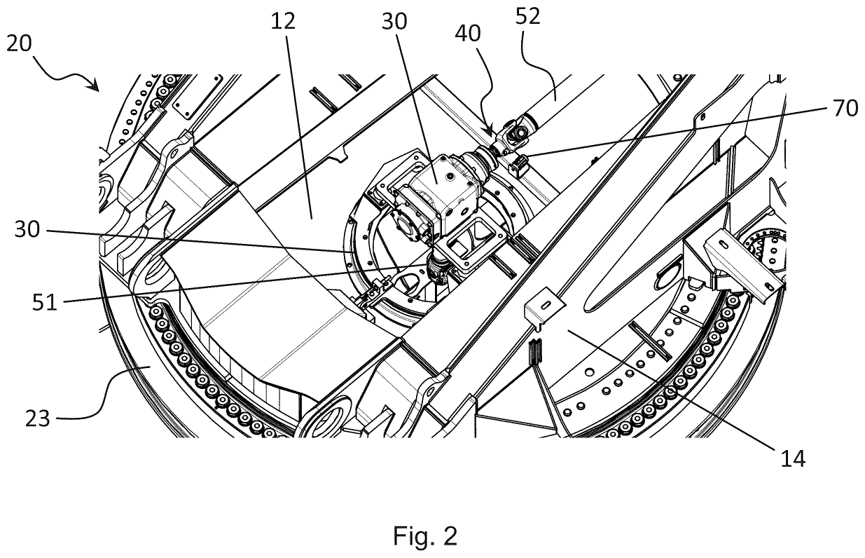

FIG. 2 shows an exemplary embodiment of the drive system according to the disclosure or the power transmission means 30 in a perspective view with a view of the slewing ring 23 between the undercarriage and superstructure 12, 14. Here, parts of the superstructure 14 are hidden in order to provide a view of the power transmission means 30 located within the slewing ring 23. In this exemplary embodiment, the latter is configured as an angular gearing 30, which is mechanically connected to the first shaft 51 on the underside and to the second shaft 52 at the side via the aforementioned mechanical interface 40. The shafts 51, 52 can have Cardan joints, as can be seen in FIG. 2. In this exemplary embodiment, the power transmission means 30 is rotatably connected to the undercarriage 12 and also remains on the undercarriage 12 when the undercarriage 12 is moved separately (i.e. without the superstructure 14).

In the exemplary embodiment shown, the mechanical interface 40 is configured as a quick-release coupling in order to be able to quickly and easily disconnect the second shaft 52 from the angular gearing 30 or couple it to the latter.

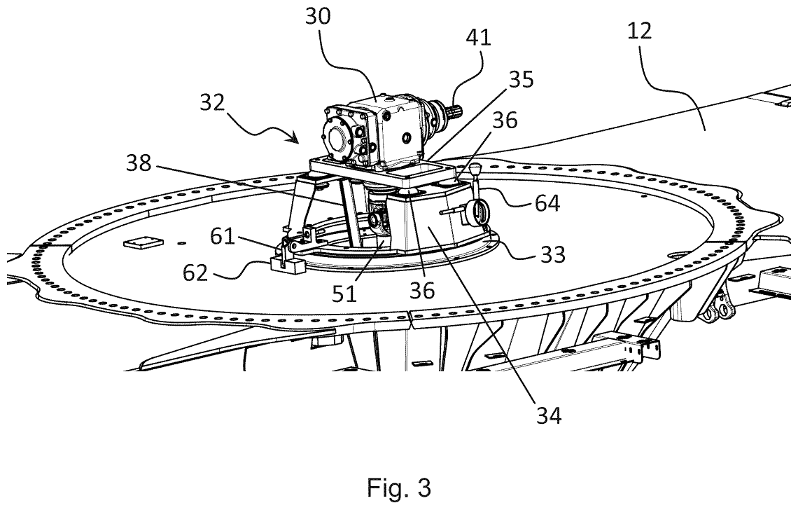

FIG. 3 shows the angular gearing 30 with the superstructure 14 removed, wherein parts of the slewing ring 23 connected to the undercarriage 12 are hidden. The angular gearing 30 is firmly connected to the undercarriage 12, or more precisely to the upper side of the undercarriage 12, via a bearing arrangement 32. The bearing arrangement 32 comprises a further slewing ring 33, which is optionally formed as a rolling bearing. The mobile crane 10 thus has two slewing rings 23, 33, which can rotate independently of each other. To differentiate between them, the slewing ring of the bearing arrangement 32 is referred to below as the first slewing ring 33 and the slewing ring of the coupling device 20 as the second slewing ring 23. In particular, the first slewing ring 33 is not used to support the superstructure 14, but to rotatably support and guide the power transmission means 30 so that it can follow the rotary movement of the superstructure 14. The two slewing rings 23, 33 are arranged concentrically to each other.

In the exemplary embodiment shown, the bearing arrangement 32 comprises a bracket 34, which is connected to the first slewing ring 33. The angular gearing 30 is connected to a holder 35, which is connected to the bracket 34 via an arrangement of damping elements 36. The exemplary embodiment shown has a symmetrical arrangement of four damping elements 36, which can be formed as elastomer bearings, for example. An arrangement of springs is also conceivable. The elastic mounting of the angular gearing 30 can compensate for relative movements between the undercarriage and superstructure 12, 14, wherein the vibrations of the angular gearing 30 are transmitted to the undercarriage 12.

The bearing arrangement 32 can comprise a driver 38 (cf. FIG. 3), which can be connected to the bracket 34 or the holder 35, for example. A rotary movement of the bearing arrangement 32 and thus of the superstructure 14 can be transmitted via a driver 38 to a slip ring transmitter of a slip ring arrangement arranged in the rotary feedthrough. The slip ring arrangement can surround the first shaft 51 annularly.

FIG. 3 shows the part of the quick-release coupling forming the mechanical interface 40 on the angular gearing side. The quick-release coupling comprises a first quick-coupling part 41 in the form of a profiled pin arranged on the angular gearing 30. The end of the second shaft 52 pointing towards the angular gearing 30 has a complementarily shaped receptacle, which can be pushed over the pin 41 and thus forms a second quick-release coupling part. As a result, the second shaft 52 can be quickly and easily separated from the angular gearing 30 for the disassembly of the superstructure 14 or connected to it for the assembly of the superstructure 14.

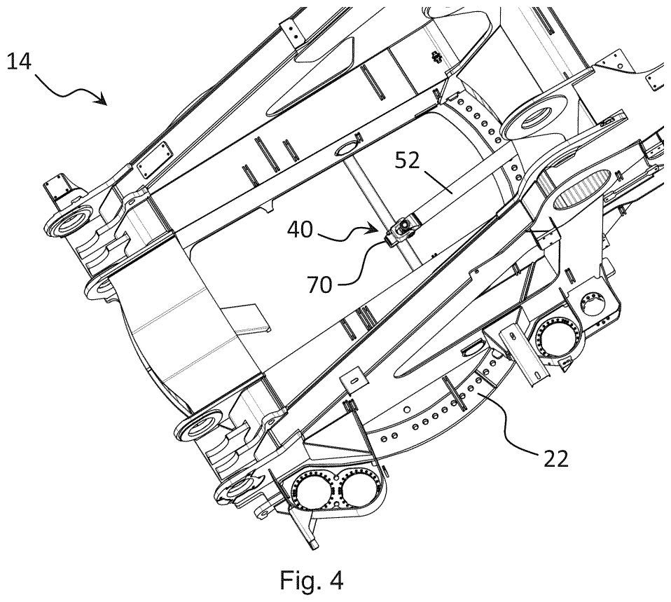

The dismantled superstructure 14 is shown in a perspective view in FIG. 4. In this exemplary embodiment, the second shaft 52 is mounted in a holding device 70. This can have a corresponding pin in the same way as the angular gearing 30, so that the receptacle of the second shaft 52 (i.e. the second quick-release coupling part) can be connected to it in a transport position. As a result, the second shaft is secured in the transport position during transport of the superstructure 14.

In the working position, in which the superstructure 14 is connected to the undercarriage 12, the angular gearing 30 is coupled to the superstructure 14 so that both rotate around a common axis of rotation. This is made possible by the two slewing rings 23, 33, which means that the superstructure consumers can be driven via the mechanical drive system in any rotational position of the superstructure 14. In the transport position, however, in which the superstructure 14 is detached from the undercarriage 12, the angular gearing 30 should be connected to the undercarriage 12 in a rotationally fixed manner so that it does not move unintentionally when travelling on the road, for example.

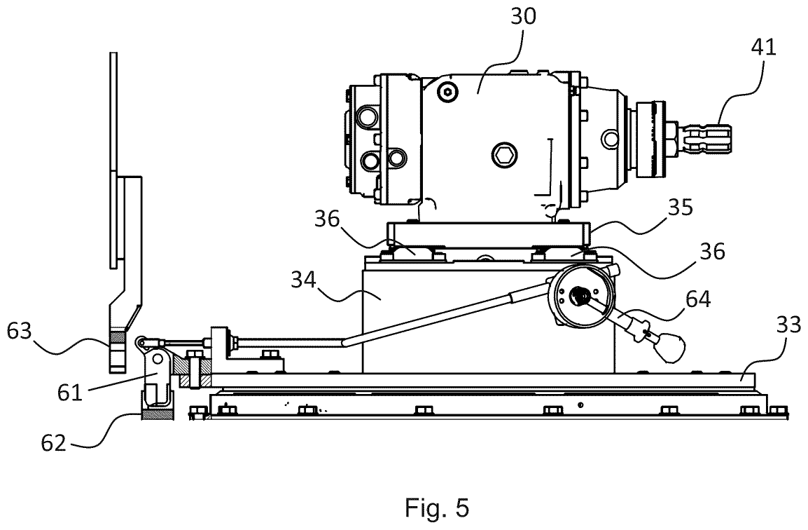

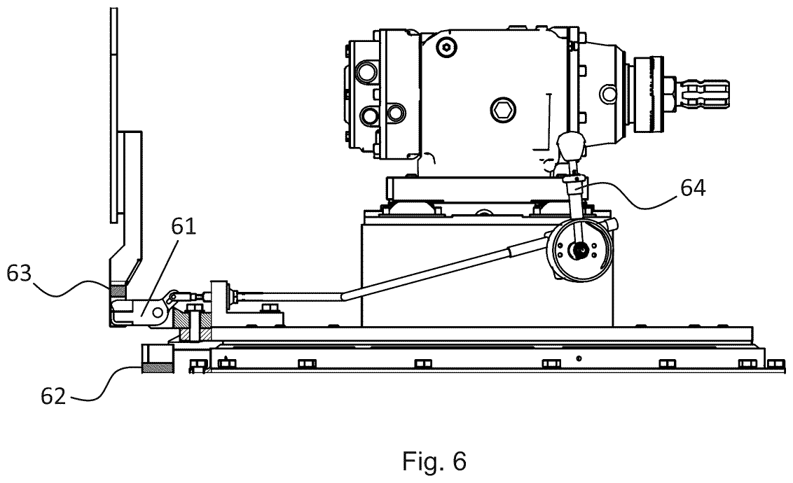

For this purpose, the mobile crane 10 can comprise a locking device, which is shown in FIGS. 5 and 6, each of which shows a side view of the bearing arrangement 32 with the superstructure 14 dismantled.

In the exemplary embodiment shown, the locking device comprises a Bowden cable that can be operated manually via a lever 64 (=actuating element) arranged on the bracket 34. A first locking element 61 (safety latch) in the form of a safety latch is pivotably mounted on a bracket bolted to the first slewing ring 33. A second locking element 62 in the form of a receptacle is located on the upper side of the undercarriage 12 at the corresponding and suitably defined position to the side of the first slewing ring 33, into which the locking bolt 61 can be retracted in a first position (cf. FIG. 5). In the first position, the bearing arrangement 32 and thus the angular gearing 30 is connected to the undercarriage 12 for conjoint rotation and thus the only degree of freedom is cancelled.

There is a third locking element 63 on the superstructure 14 in the form of a corresponding receptacle for the locking bolt 61, which in a second position (cf. FIG. 6) moves into the receptacle 63 on the superstructure 14 and couples the bearing arrangement 32 to the superstructure 14 for conjoint rotation. For this purpose, the superstructure 14 must be in a certain angular position relative to the undercarriage 12 so that the locking bolt 61 can be retracted into the receptacle 63. As already described, the swivelling of the safety catch 61 or the transition between the first and second position is effected via the Bowden cable. However, other mechanisms for actuating the first locking element 61 are also conceivable, for example via a piston rod. It is also conceivable that the actuation is performed by an actuator.

To establish the working position, the superstructure 14 is placed on the undercarriage 12. The superstructure 14 is centered by the coupling device 20 being received at the quick-release coupling device 26 (“Quick Connection”, cf. FIG. 7). The remote actuation of the locking device releases the coupling of the bearing arrangement 32 with the undercarriage 12 and establishes it with the superstructure 14. The locking bolt 61 swivels into the receptacle 63 on the superstructure 14 (cf. FIG. 6). This transfers the rotary movement of the superstructure 14 to the bearing arrangement 32 and thus to the angular gearing 30. In order to connect the second universal-joint shaft 52 to the angular gearing 30, said shaft must be removed from the holding device 70 and connected to the angular gearing 30 using the quick-release coupling 40 (cf. FIG. 2).

The lever 64 must be in the coupling position with the superstructure 14 before the superstructure 14 is rotated. It is conceivable that the second shaft 52 can only be mounted if the lever 64 is in the correct position. Alternatively, monitoring would also be conceivable, for example by means of one or more sensors which are arranged on the superstructure 14 and/or on the undercarriage 12 and which transmit the correct position of the superstructure 14 in relation to the undercarriage 12, which enables coupling via the lever 64, to a control unit of the work machine 10.

In terms of the degrees of freedom, the first slewing ring 33 is constructed in a similar way to the second slewing ring 23. The only relevant degree of freedom here is rotation. The absorption of the acceleration forces is particularly important for travelling on public roads and during operation of the first shaft 51.

As an alternative to the solution shown in FIGS. 2-6, the power transmission means 30 could also be connected to the superstructure 14 for conjoint rotation and connected or connectable to the first shaft 51 via a mechanical interface 40, in particular in the form of the quick-release coupling shown. In this case, the power transmission means 30 would remain on the superstructure 14 and be separated from the first shaft 51 during dismantling.

FIGS. 1-7 show example configurations (to scale, although other relative dimensions may be used) with relative positioning of the various components. Unless otherwise noted, if shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example

### LIST OF REFERENCE SIGNS

10 work machine (mobile crane)
12 undercarriage
14 superstructure
15 undercarriage driver's cab
16 boom
17 superstructure driver's cab
18 luffing cylinder
20 coupling device
21 first slewing ring part (first quick-release coupling part)
22 second slewing ring part (second quick-release coupling part with roller slewing ring)
23 second slewing ring
24 locking bolt
26 quick-release coupling device
30 power transmission means (angular gearing)
32 bearing arrangement
33 first slewing ring
34 console
35 holder
36 damping element
38 driver
40 mechanical interface (quick-release coupling)
41 first quick-release coupling part
51 first shaft
52 second shaft
61 first locking element (safety latch)
62 second locking element
63 third locking element (receptacle)
64 actuating element
70 holding device

1. A mobile work machine, comprising a movable undercarriage, a superstructure which is rotatably mounted on the undercarriage and which is separably connected to the undercarriage via a coupling device, and a mechanical power transmission means, wherein the undercarriage comprises a motor and a first shaft that can be mechanically driven by the motor and that is mechanically connected to a second shaft of the superstructure via the power transmission means,
wherein
the power transmission means is mounted rotatably on the undercarriage and is detachably connected to the second shaft via a mechanical interface, or in that the power transmission means is mounted on the superstructure for conjoint rotation and is detachably connected to the first shaft via a mechanical interface.

2. The mobile work machine according to claim 1, wherein the power transmission means is or comprises an angular gearing.

3. The mobile work machine according to claim 1, wherein the power transmission means is mounted rotatably on the undercarriage and is detachably connected to the second shaft via a mechanical interface, wherein the work machine further comprises a bearing arrangement which supports the power transmission means and rotatably connects it to the undercarriage.

4. The mobile work machine according to claim 3, wherein the coupling device comprises a second slewing ring.

5. The mobile work machine according to claim 4, wherein the bearing arrangement is arranged within the second slewing ring, wherein the first slewing ring is configured so as to be rotatable independently of the second slewing ring.

6. The mobile work machine according to claim 3, wherein the bearing arrangement comprises at least one damping element, via which the power transmission means is connected to the undercarriage in a vibration-damped manner, wherein the bearing arrangement comprises an arrangement of several damping elements symmetrical to an axis of rotation of the power transmission means.

7. The mobile work machine according to claim 3, wherein the bearing arrangement comprises a driver which interacts with a slip ring arrangement of the coupling device and transmits a rotary movement of the bearing arrangement to a slip ring transmitter of the slip ring arrangement.

8. The mobile work machine according to claim 1, wherein the first shaft and/or the second shaft comprises a universal-joint shaft, and/or wherein the first shaft comprises a king shaft and an angular gearing.

9. The mobile work machine according to claim 1, wherein the mechanical interface is or comprises a quick-release coupling, wherein the quick-release coupling comprises a first quick-release coupling part with a profiled pin and a second quick-release coupling part with a receptacle profiled to complement the pin, which are detachably connectable to one another in a frictionally engaged and/or form-fitting manner.

10. The mobile work machine according to claim 1, further comprising a holding device, with which the first or second shaft separated from the power transmission means can be releasably connected in a bearing position.

11. The mobile work machine according claim 3, further comprising a locking device by means of which the power transmission means can be locked reversibly and in a rotationally rigid manner either with the undercarriage or with the superstructure, wherein the power transmission means is lockable in a rotationally rigid manner via the locking device to the superstructure in a working state in which the superstructure is connected to the undercarriage, and to the undercarriage in a transport state in which the superstructure is separated from the undercarriage.

12. The mobile work machine according to claim 11, wherein the locking device comprises a first locking element, which is connected to the bearing arrangement and which can optionally be brought into engagement with a second locking element arranged on the undercarriage or with a third locking element arranged on the superstructure, wherein the locking device comprises a Bowden cable.

13. The mobile work machine according to claim 1, wherein the superstructure does not have a drive motor, and/or wherein the superstructure comprises at least one consumer and all consumers of the superstructure are driven directly or indirectly via the second shaft.

14. The mobile work machine according to claim 1, which is formed as a mobile crane, wherein the undercarriage comprises a wheeled chassis and the superstructure comprises a boom wherein the superstructure is removably from the undercarriage via the coupling device and can be transported separately, wherein the undercarriage is movable independently without superstructure.

15. A drive system for a mobile work machine according to claim 1, comprising a motor, a first shaft which can be mechanically driven by the motor, a second shaft, and a power transmission means which is detachably connected to the first shaft and/or to the second shaft via a mechanical interface and mechanically connects the two shafts to one another, wherein the drive system optionally comprises a slewing ring via which the power transmission means can be connected or is connected rotatably to an undercarriage of the work machine.

16. The mobile work machine according to claim 1, wherein the work machine is a mobile crane.

17. The mobile work machine according to claim 2, wherein the power transmission means is or comprises an angular gearing which comprises a first mechanical interface and/or a second mechanical interface via which the angular gearing is mechanically detachably connected to the first shaft and/or to the second shaft.

18. The mobile work machine according to claim 3, wherein the bearing arrangement comprises a first slewing ring connected to the undercarriage and formed as a rolling bearing.

19. The mobile work machine according to claim 4, wherein the second slewing ring, is formed as a rolling bearing and which comprises first slewing ring part connected to the undercarriage and a second slewing ring part connected to the superstructure, which are detachably connected to one another via a quick-release coupling device, which comprises a boltable tongue-and-groove connection.

20. The mobile work machine according to claim 10, wherein the first or second shaft separated from the power transmission means can be releasably connected via a quick-release coupling, wherein the power transmission means is arranged mounted rotatably on the undercarriage and the holding device is arranged on the superstructure.
